(19) United States
(12) Patent Application Publication
(10) Pub. No.: US 2024/0198716 A1
(43) Pub. Date: Jun. 20, 2024

(54) FOLDABLE CLIPBOARD

(71) Applicant: Muhammad Sarfraz Khaliq, Brea, CA (US)

(72) Inventor: Muhammad Sarfraz Khaliq, Brea, CA (US)

(21) Appl. No.: 18/584,435

(22) Filed: Feb. 22, 2024

Related U.S. Application Data
(63) Continuation-in-part of application No. 18/389,576, filed on Nov. 14, 2023.
Application No. 18/389,576 is a continuation-in-part of application No. 17/555,472, filed on Dec. 19, 2021, now Pat. No. 11,872,835.
Application No. 18/389,576 is a continuation-in-part of application No. 17/685,357, filed on Mar. 2, 2022, now Pat. No. 11,850,879.
(60) Provisional application No. 63/245,804, filed on Sep. 18, 2021.
(60) Provisional application No. 63/245,804, filed on Sep. 18, 2021.

(51) Int. Cl. B42F 9/00

(52) U.S. Cl. CPC B42F 9/001

(57) ABSTRACT

A foldable clipboard includes at least two folding panels in which each of the folding panels cooperate to form a single planar surface when in an extended position, and each of the folding panels are configured to pivotally move to form a folded position, such that the foldable clipboard is folded into a size to fit in a pocket of a garment, or other carrying devise.

### CROSS REFERENCE TO RELATED APPLICATIONS

The present non-provisional patent application claims the benefit of U.S. non-provisional patent application Ser. No. 18/389,576, entitled “FOLDABLE CLIPBOARD,” filed Nov. 14, 2023, which claims the benefit of U.S. non-provisional patent application Ser. No. 17/555,472, entitled “FOLDABLE CLIPBOARD,” filed Dec. 19, 2021, which claims the benefit of U.S. provisional patent application No. 63/245,804, filed Sep. 18, 2021; and U.S. non-provisional patent application Ser. No. 18/389,576 entitled “FOLDABLE CLIPBOARD,” filed Nov. 14, 2023, also claims the benefit of U.S. non-provisional patent application Ser. No. 17/685,357, entitled “FOLDABLE CLIPBOARD,” filed Mar. 2, 2022, which claims the benefit of U.S. provisional patent application No. 63/245,804, filed Sep. 18, 2021, all of which are hereby incorporated by reference herein for all purposes.

### TECHNICAL FIELD

The present invention relates to a foldable clipboard, and more particularly to a multi-panel foldable clipboard in which two, three, or more panels are planar relative to each other in an extended position, and at least one panel is configured to pivotally move to overlap another panel in a folded position.

### BACKGROUND

Clipboards are utilized in a variety of different environments where a portable writing surface may be required. To this end, conventionally known basic clipboards generally consist of a flat panel or board and a clip mounted to one end of the board. The clip retains the writing materials or other documents being written upon against the writing surface provided by the board. Clipboards are an essential mobile writing platform that provides a flat surface for writing or drawing, and which incorporates a clip device to secure a sheet of writing material. Clipboards of varying sizes and shapes are available commercially.

Existing clipboards are cumbersome to carry due to their large size and are inconvenient to use due to their large size. These clipboards have been restricted to merely carrying a few pages of writing material, and sometimes the pages become torn or damaged because such writing materials are unprotected on regular clipboards. These problems cause difficulty for people who, for example, but not by way of limitation, travel from one location to another, or are research scholars, physicians, healthcare workers, or those who work outside, and the like.

While some of the foregoing are alleviated by computer-based electronics, such as cell phones, computer tablets, and lap top computers, it is not always easy even when utilizing one or more of these options. Typing on cell phones and tablets is not always easy when a person is in the field. While typing can be easier on a laptop computer, they are expensive and bulky to carry into the field. Further, sun light can make the screen of any of these products difficult to see. A low technology option does not carry these problems, except for size and the ability to write an a “regular” sheet of writing material or, alternatively, an irregular sheet, such as, for example only, a standard 8.5 inch by 11-inch sheet, an A4 size sheet, an 8.5 by 14 inch sheet, and the like, of a sheet of writing material. The sheet size of, for example, an 8.5 inch by 11 inch or 8.5 by 14 inch or longer sheet of writing material makes it more difficult to easily store in one person's pocket, and the like, when in the field, such as, for example, but not by way of limitation, when checking electrical lines, sewer lines, livestock, land boundaries, or in a health care situation, as patient intake information, patient medications, patient vital signs, nursing information, physician's orders, and the like.

It would be desirable to have a low technology solution which permitted writing on one or more sheets of writing material of various large or small sizes. Such a solution may carry one sheet or several sheets of writing material, and such a solution would desirably be foldable to protect the writing material (s) and prevent it/them from being crumpled and where necessary maintain the confidentiality of the information obtained on the one or more sheets of writing material, yet the solution would ideally fit within a small carrier, such as, for example only, a pocket, a purse, bag, a pack, and the like.

### SUMMARY OF THE INVENTION

In one embodiment, a foldable clipboard, comprises at least two folding panels which are configured to form a single planar surface when positioned in an expanded position when an edge of each panel of the at least two folding panels is positioned next to each other are positioned to abut each to provide a planar expanded position. The foldable clipboard also includes at least one plurality of hinge assemblies, each hinge of the plurality of hinge assemblies positioned in a transverse alignment relative to the other and relative to an expanded position of the foldable clipboard, each hinge of the at least one plurality of hinge assemblies is formed along at least one adjacent edge of each of the at least two folding panels to pivotally connect the at least two folding panels. Each hinge of the plurality of hinge assemblies is substantially cylindrical and includes a stop. Another stop is also formed adjacent each hinge, on the edge of the at least first and second folding panels, to provide a plurality of stops, such that when the at least first and second folding panels are moved into the expanded position, each stop provided with each hinge abuts one stop of the plurality of stops formed along each edge of the at least first and second folding panels, to form the expanded position. When the at least two panels of the foldable clipboard are moved from the expanded position into a folded position, each abutted stop moves away from the other to so that the at least first and second folding panels are movable into an overlapped position relative to each other to provide a folded position.

In one aspect of the one embodiment, the plurality of hinge assemblies comprise at least two hinges, each of which includes a stop, and at least two additional stops, each additional stop formed on the adjacent edge of the first and second folding panels, respectively. Each hinge assembly of the plurality of hinge assemblies includes a substantially cylindrical hinge with an opening formed therethrough formed from a neck which forms a stop. Another stop is formed along an edge of each of the first and second folding panels, next to each hinge of the plurality of hinge assemblies. Moreover, each hinge of the plurality of hinge assemblies includes at least a portion of a pin positioned through the opening therein.

In another aspect of the one embodiment, the at least first and second folding panels fold transversely relative to an axial alignment of the foldable clipboard when in the expanded position.

In a further aspect of the one embodiment, the foldable clipboard further comprises a clip. the clip is a spring-loaded clip, and the clip includes a mounting bracket connected to the foldable clipboard.

In still a further aspect of the one embodiment, a pair of ends of the first folding panel are each rounded, and a pair of ends of the second folding panel are each rounded.

In yet another aspect of the one embodiment, the at least two panels are constructed from at least one of metal, plastic, and cardboard.

And in another aspect of the one embodiment, the at least two panels comprise a first folding panel, a second folding panel, and a third folding panel. A t least one of the first folding panel and the third folding panel overlaps the second folding panel to form the folded position. The plurality of hinge assemblies comprises at least a first plurality of hinge assemblies and a second plurality of hinge assemblies. Each hinge of the first plurality of the hinge assemblies and the second plurality of hinge assemblies includes a substantially cylindrical hinge with an opening therethrough and a stop. Each hinge includes at least a portion of a pin positioned through the opening therein.

In a further aspect of the first embodiment, the first folding panel, the second folding panel, and the third folding panel fold transversely relative to an axial alignment of the foldable clipboard when in the expanded position.

In still another aspect of the one embodiment, the first folding panel and the third folding panel each includes a pair of rounded ends.

### BRIEF DESCRIPTION OF THE DRAWINGS

The structure, operation, and advantages of the present invention will become further apparent upon consideration of the following description taken in conjunction with the accompanying figures. The figures are intended to be illustrative, and not limiting.

FIG. 1 is an upper surface perspective view of the foldable clipboard in an open expanded position, according to the present invention;

FIG. 2 is a perspective view showing a partial folding of the foldable clipboard of FIG. 1;

FIG. 3 is a perspective view of a complete folded position of the foldable clipboard of FIG. 1;

FIG. 4 is an upper plan view of the foldable clipboard of FIG. 1;

FIG. 5 is a lower pan view of the foldable clipboard of FIG. 1;

FIG. 6 is a right side view of the foldable clipboard of FIG. 1;

FIG. 7 is a left side view of the foldable clipboard of FIG. 1;

FIG. 8 is a plan view from an upper end of the foldable clipboard of FIG. 1;

FIG. 9 is a plan view from a lower end of the foldable clipboard of FIG. 1;

FIG. 10 is an upper surface perspective view of another similar foldable clipboard in an open expanded position, according to the present invention;

FIG. 11 is an upper plan view of the foldable clipboard of FIG. 10;

FIG. 12 is a lower pan view of the foldable clipboard of FIG. 10;

FIG. 13 is a right side view of the foldable clipboard of FIG. 10;

FIG. 14 is a left side view of the foldable clipboard of FIG. 10;

FIG. 15 is a plan view from an upper end of the foldable clipboard of FIG. 10;

FIG. 16 is a plan view from a lower end of the foldable clipboard of FIG. 10;

FIG. 17 is a perspective view showing a partial folding of the foldable clipboard of FIG. 10; and

FIG. 18 is a perspective view of a complete folded position of the foldable clipboard of FIG. 10.

### DETAILED DESCRIPTION OF THE PREFERRED EMBODIMENTS

In the description that follows, numerous details are outlined to provide a thorough understanding of the present invention. It will be appreciated by those skilled in the art that variations of these specific details are possible while still achieving the results of the present invention.

Exemplary illustrative embodiments of the invention should be interpreted as example(s) and non-limiting. The relationship between various components, where they are located, their composition(s), their operation, and sometimes their sizes relative to the desired operation of the invention are significant.

The foldable clipboard 10 is designed as an improvement to a traditional flat, rigid clipboard and other known clipboards. It is designated as a “mini” foldable clipboard 10 because it can be folded to a size which is reasonable to place, for example, but not by way of limitation, in a suit jacket pocket, a laboratory coat pocket, a standard coat pocket, a pants pocket, a purse, bag, pack, and the like. The foldable clipboard 10 is for example, but not by way of limitation, of particular use to doctors and medical personnel because the foldable clipboard 10 can be folded to comfortably fit into a medical coat pocket, a scrubs pocket, and even a jeans pocket. For example, the foldable clipboard 10 may be utilized to secure patient assessment forms, nursing protocols, medication lists, and all documentation in a HIPAA compliant secure foldable clipboard.

However, it is within the terms of the embodiment that the foldable clipboard 10 may also be used to accommodate the needs of a variety of different people in a variety of services or work environments, as described in non-limiting examples herein. For example, the foldable clipboard may be used for construction, for project management, for holding preprinted sheet for building codes, and the like.

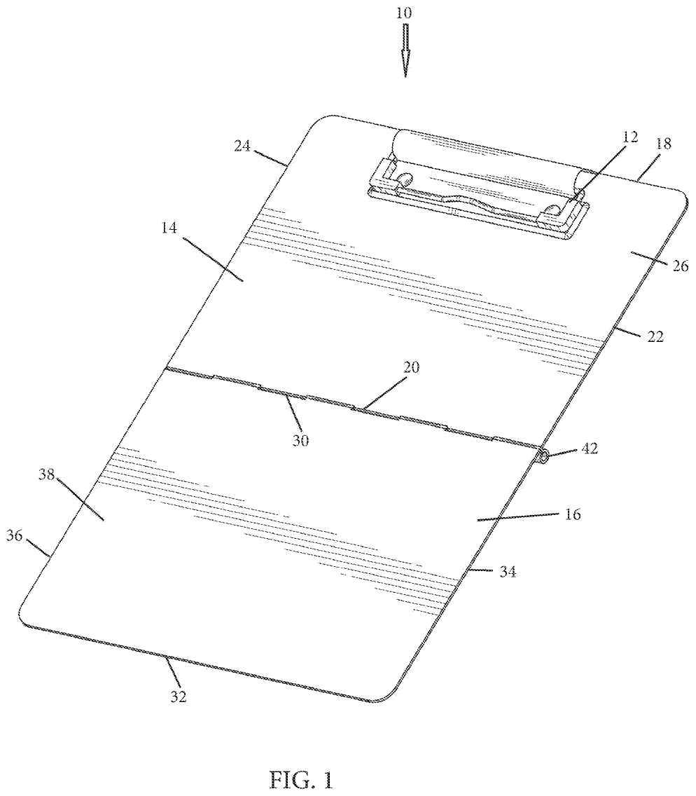

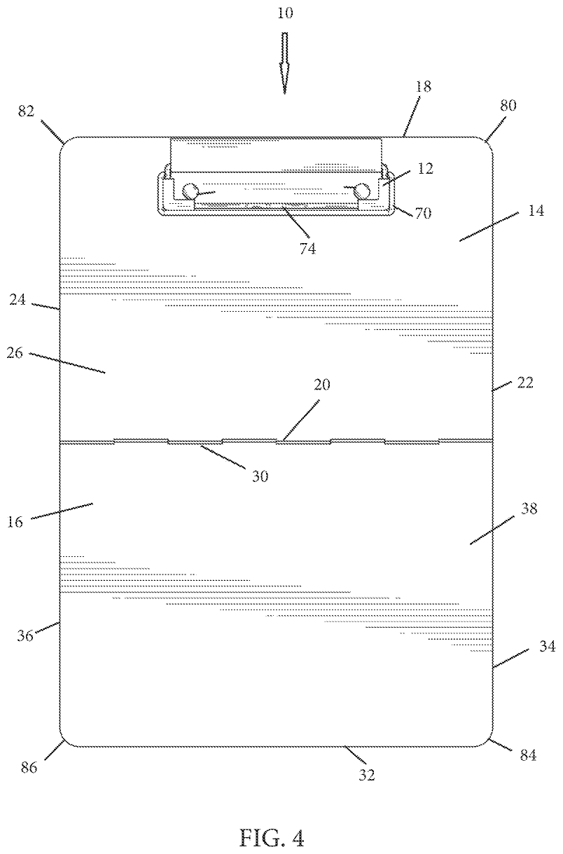

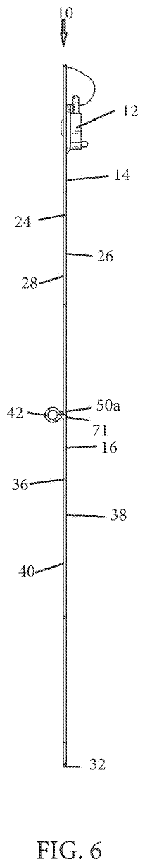

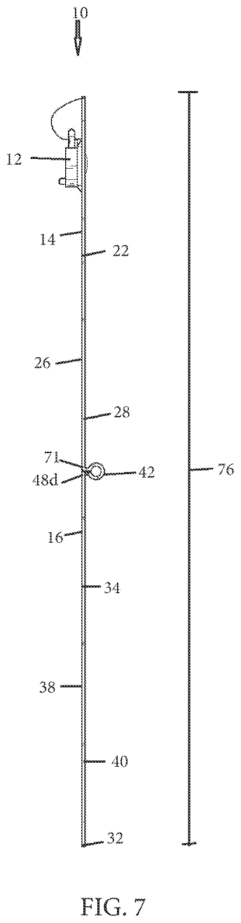

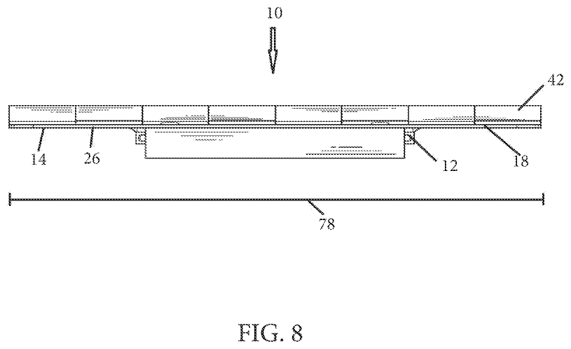

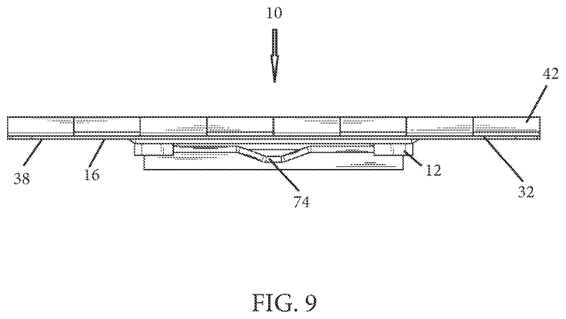

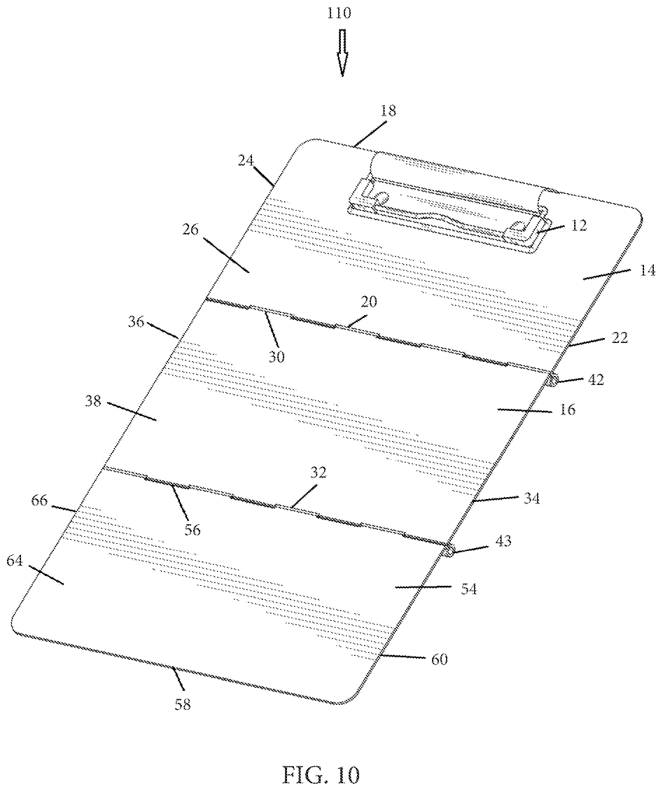

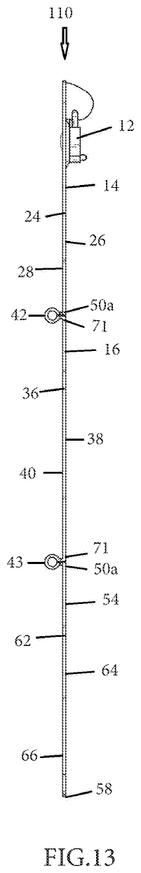

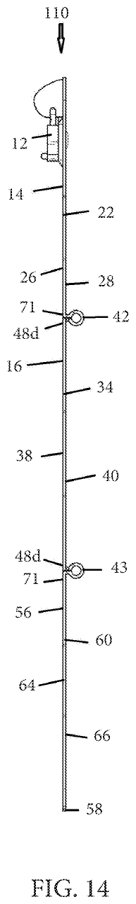

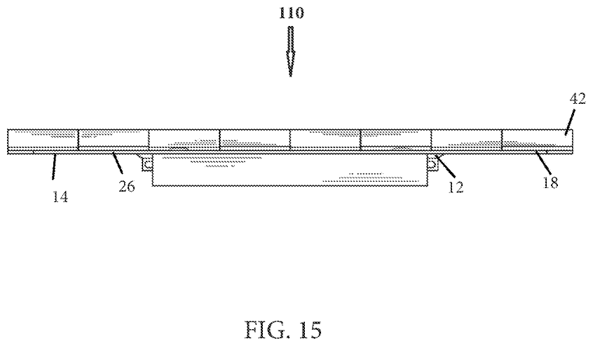

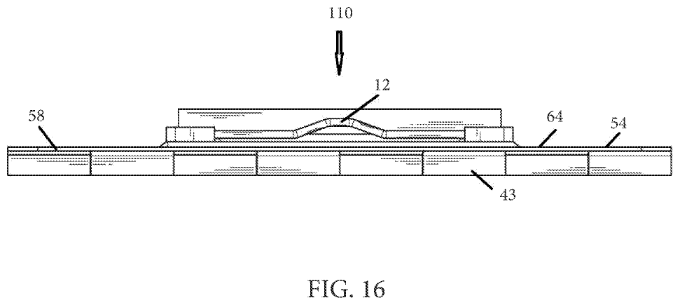

Referring now to FIGS. 1-9 and 10-18, the foldable clipboard 10 and 110, respectively, desirably may include a clip 12, as well as a first folding panel 14 and a second folding panel 16. The first folding panel 14 and the second folding panel 16 (including the third folding panel 54 shown in FIGS. 10-18 and described in further detail below) are each desirably substantially planar. “Substantially planar” as used herein, refers to the planar portion of each panel, and not including any portion forming the clip 12 or one or more hinges. Further, each first folding panel and second folding panel 14, 16 (and third folding panel 54 of 110) are also, for example, but not by way of limitation, substantially rectangular. “Substantially rectangular” as used herein, means that at least eighty-five (85) percent of the shape is rectangular, but the shape may include minor variations, such as flanges, hinges, and the like. Each first folding panel and second folding panel 14, 16 (and third folding panel 54 of 110), may have different widths and/or different lengths, to enable folding and expansion of the foldable clipboard 20. While first and second folding panels 14 and 16, as well as first, second, and third folding panels 14, 16, (and 54 of 110) are illustrated, it will be understood that additional or fewer panels may be utilized, so long as such a foldable clipboards 10, 110 functions as described and shown herein.

The first folding panel 14 may include a clip 12, and the first folding panel 14 is defined by an upper edge 18 and a spaced-apart lower edge 20, a first side edge 22 spaced-apart from a second side edge 24, an upper surface 26 and a lower surface 28. The second folding panel 16 includes an upper edge 30 and a spaced-apart lower 32, and a first side edge 34 spaced-apart from a second side edge 36. The second folding panel 16 includes an upper surface 38, and a lower surface 40.

And now referring to three panel clipboard 110, as illustrated in at least FIGS. 10-18, the third folding panel 54 is next to and connected to the second folding panel 16. The third folding panel 54 includes an upper edge 56, and a spaced-apart lower edge 58, a first side edge 60 spaced-apart from a second side 62, and an upper surface 64, and a lower surface 66.

For both the clipboard 10 and 110, the clip 12 may be positioned for example, but not by way of limitation, on the upper surface 26 of the first folding panel 14 near the upper edge 18 thereof, and may include the mechanism, i.e., a clip 12, to hold writing material (not shown) to the foldable clipboard 10. While one type of clip 12 is illustrated and described in detail herein, it will be appreciated that any low-profile clip which holds writing material to the foldable clipboard 10 may be used. For example, the present clip 12 may include a bracket 70 and a pair of connectors 72 which connect the bracket 70 to the foldable clipboard 10. The bracket 70 may desirably include a spring-loaded clip in the form of a handle 74 which is urged toward the foldable clipboard 10. When the handle 74 is raised, writing material may be positioned on the foldable clipboard 10 and when the handle 70 is released, the handle 74 is desirably urged toward the foldable clipboard 10 to hold the writing material in a desired position. The clip 12 and any part(s) thereof may be formed from metal and/or plastic. The clip 12 illustrated herein is commercially available. The clip 12 may be connected to the foldable clipboard 10 via welding, adhesives, connectors (as shown herein) or by any other manner known in the art.

A plurality of hinge assemblies 42 of foldable clipboard 10 (FIGS. 1-9) or a first plurality of hinge assemblies 42 of foldable clipboard 110 (shown in FIGS. 10-18) are desirably formed from a portion or each first and second folding panel 14, 16 (and third folding panel 54 of foldable clipboard 110) along shared edges lower edge 28 of first folding panel 14 and upper edge 30 of second folding panel 16 of foldable clipboard 10, as well as between the lower edge 30 of second folding panel 16 and the upper edge 56 of third folding panel 54 as shown in foldable clipboard 110 (shown in FIGS. 10-18).

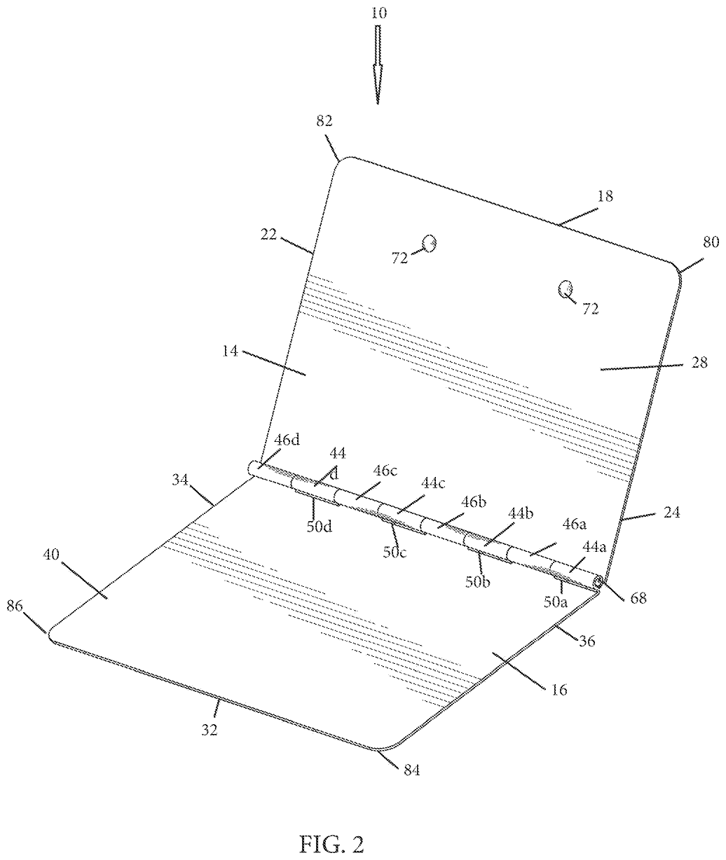

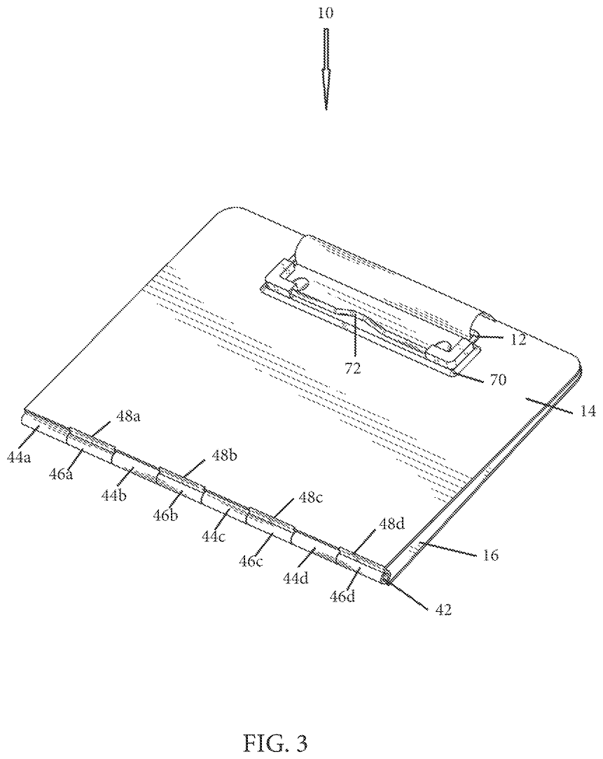

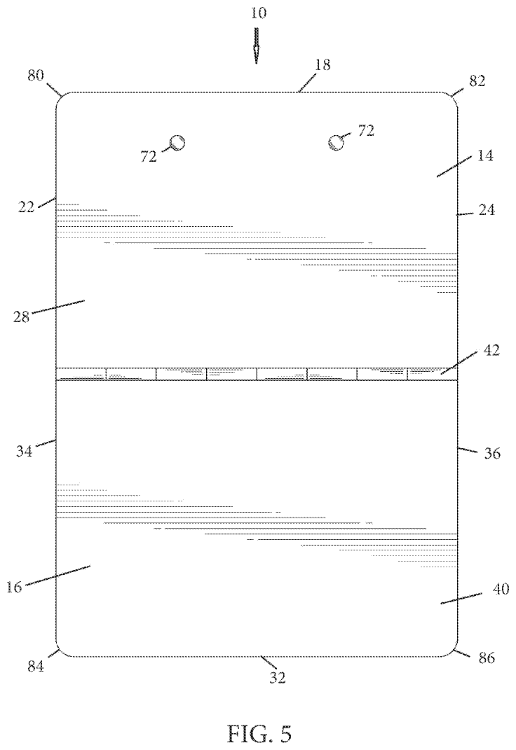

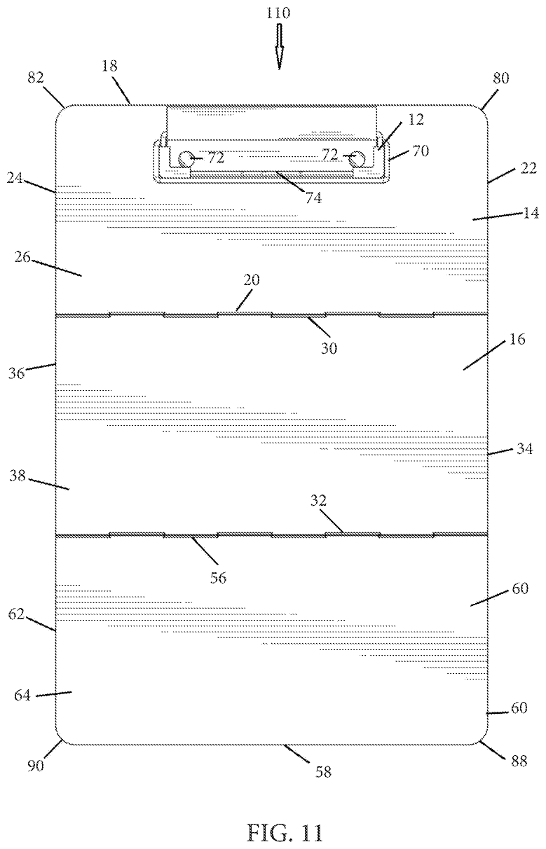

As illustrated in FIGS. 2, 3 and 5-7 for foldable clipboard 10 and in FIGS.10, 11,13, 14, 17, and 18 for foldable clipboard 110, the plurality of hinge assemblies 42 may include, for example, but not by way of limitation, four hinges formed along the lower edge 20 of the first folding panel 14 and four hinges formed along the upper edge 30 of the second folding panel 16. As illustrated in FIGS. 5-7, the plurality of hinge assemblies 42 are formed to be substantially cylindrically but remain attached to each first and second folding panel 14, 16, therefore forming a slightly irregular and not completely closed cylinder-shape. Therefore, “substantially cylindrical” as used herein desirably may refer to a cylinder shape which may be formed to have an opening formed therethrough as well as an opening formed along the cylindrical sidewall thereof. Moreover, “substantially cylindrical” may also include a “neck” which extends from at least a portion of an edge of a panel which carries and/or forms the “substantially cylindrical” shape. Each cylindrical hinge of the plurality of hinge assemblies 42 are positioned in a spaced-apart position on the lower edge 20 and the upper edge 30 of each first and second folding panel 14, 16, respectively. Therefore, as illustrated in FIGS. 2 and 3, cylindrical hinges 44a, 44b, 44c, and 44d are provided on the second edge 20 of the first folding panel 14 and are spaced apart, to permit the positioning between each of the foregoing of the cylindrical hinges 46a, 46b, 46c, and 46d which are spaced-apart and positioned on the upper edge 30 of the of the second folding panel 16.

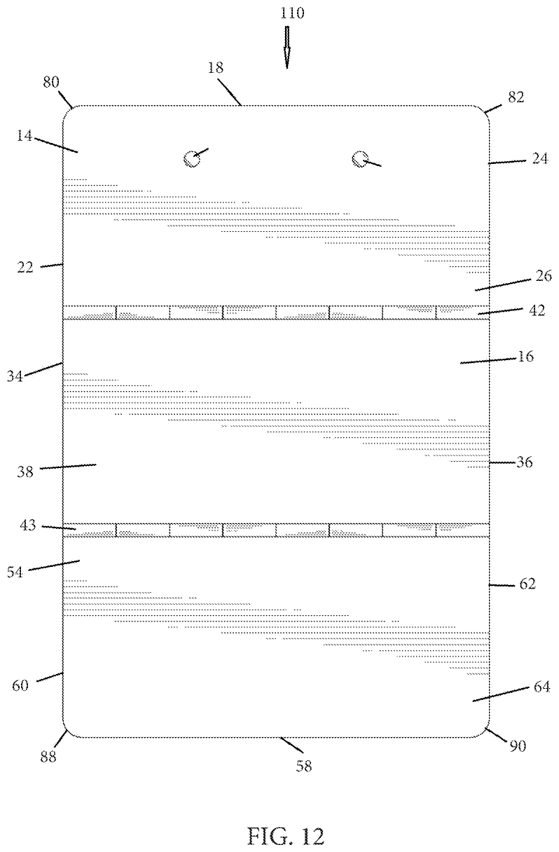

Turning to foldable clipboard 110, as illustrated in FIGS. 10-18, each cylindrical hinge of the second plurality of hinge assemblies 43 is desirably positioned in a spaced-apart position on the lower edge 32 of the second folding panel 16, and the upper edge 56 of the third folding panel 54, respectively. As shown in FIGS. 12-14, 17 and 18, the second plurality of hinge assemblies 43 desirably connects the second folding panel 16 and the third folding panel 54. The second plurality of hinge assemblies 43 are desirably identical to the first plurality of hinge assemblies 42. The cylindrical hinges 44a, 44b, 44c, and 44d are provided on the lower edge 32 of the second folding panel 16 and are spaced apart, to permit the positioning between each of the foregoing between each of the cylindrical hinges 46a, 46b, 46c, and 46d provided on the upper edge 56 of the third folding panel 54.

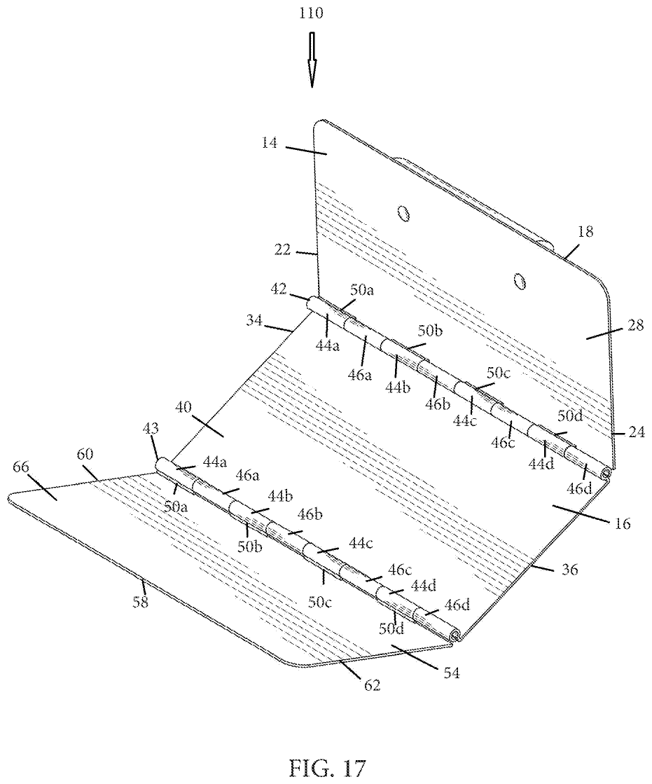

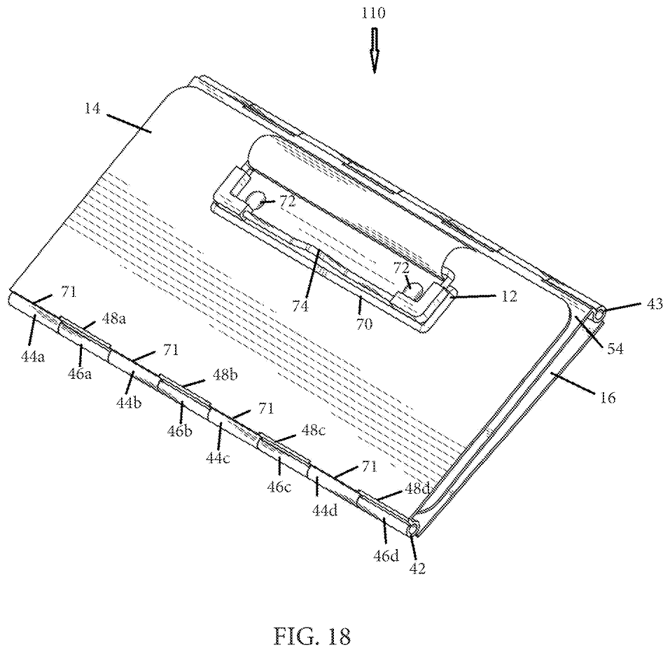

The foldable clipboard 10, as shown at least in FIGS. 2 and 3, and foldable clipboard 110, as shown in FIGS. 17 and 18, include a “cut out” to accommodate each hinge of each of the first and second plurality of hinge assemblies 42, 43; each cut out forms a “stop.” Each stop is formed next to each of the cylindrical hinges 44a-44d, on the first folding panel 14 of the clipboard, in an alternating transverse alignment thereof, namely, stops 48a, 48b, 48c, and 48d (FIG. 3 for foldable clipboard 10 and FIG. 18 for foldable clipboard 110). Similarly, another “stop” is also formed next to each of the cylindrical hinges 46a-46d, on the second folding panel 16 of the clipboard 10, in an alternating transverse alignment thereof, namely, stops 50a, 50b, 50c, and 50d.

Each cylindrical hinge 44a-44d and 46a-46d of the first plurality of hinge assemblies 42 and the second plurality of hinge assemblies 43 may be formed from a neck 71 which may extend from each respective panel 14, 16, and 54 which forms each cylindrical hinge, and which provides an additional stop 71. Therefore, each stop 48a-48d and 50a-50d abut a stop 71 of one of each hinge 44a-44d and 46a-46d, respectively, to hold the first and second folding panels of the foldable clipboard 10 in a planar expanded position relative to each other. And in addition, for foldable clipboard 110, each stop 48a-48d and 50a-50d abut a stop 71 of one of each hinge 44a-44d and 46a-46d, respectively, to hold the first, second, and third folding panels 14, 16, 54, respectively, of foldable clipboard 110 in a planar expanded position relative to each other.

It will be understood that both clipboard 10 and clipboard 110 may utilize a pin 68, or the like, which may be positioned through openings in the plurality of hinge assemblies 42 of the first and second plurality of hinge assemblies 42, 43, respectively. Such a pin 68 may be positioned to extend through the openings formed in each of the first and second plurality of hinge assemblies, 42, 43, as shown for foldable clipboard 10 at least in FIG. 2. Such a pin 68 may be utilized to hold the first and second plurality of hinge assemblies 42, 43 in a transverse alignment and while permitting pivoting of each hinge of the plurality of hinge assemblies 42, 43 in foldable clipboard 10 and foldable clipboard 110, such that folded positions and expanded positions, respectively are permitted. Any other commercially available hinge may be utilized, so long as such a hinge operates as shown and described herein.

Each first and second folding panel 14, 16 of foldable clipboard 10 and each first, second, and third folding panel 14, 16, 54 of foldable clipboard 110 may be, for example, but not by way of limitation, formed from plastic, metal cardboard, a combination there of, and/or any material commercially available and known in the art. Each panel of each foldable clipboards 10, 110, may be a uniform size or each may vary in size and/or shape, or have folding panels which vary in size and/or shape. Further, a foldable clipboard may have more than three panels, such as four panels, five panels, and the like, and may fold in any manner known.

Similarly, each first and second plurality of hinge assemblies 42, 43 (including all stops shown and described herein) of each foldable clipboards 10, 110, respectively, may also be formed from plastic, metal, any material commercially available, and/or combinations thereof. For example, but not by way of limitation, from metal or plastic, and the like. Each may be integrally formed with each panel 14, 16, 54 as shown and described herein, and the pivot pin 68 may be formed therewith or added to each hinge later.

Alternatively, any one of the first plurality and second plurality of hinge assemblies 42, 43, may be connected to first, second, and third folding panels 14, 16, 54 by welding, adhering, connecting via connectors, and all other forms of connection known and commercially available. Varying a position of any hinge of the first and second plurality of hinge assemblies 42, 43 is also enabled herein, as is a variation of size and/or spacing of any hinge thereof. Moreover, the first and/or second plurality of hinge assemblies 42, 43, may comprise only more than one hinge, or may include any number of hinges.

For example, but not by way of limitation, the foldable clipboard 10 may have a length 76 of 12 inches and a width 78 of 8.5-9 inches. Alternatively, however, the length 76 and or width 78 may be longer and/or shorter. A depth or thickness of the foldable clipboards 10, 110 may range from 0.5 millimeter to 5 millimeters. It will be understood that other lengths, depths, and widths of the foldable clipboards 10, 110 are possible, so long as the foldable clipboards 10, 110, operate as shown and described in detail herein, and includes the advantages shown and described herein.

Both foldable clipboards 10 and 110 desirably include rounded corners for panels which are not directly connected together. For example, foldable clipboard 10 includes rounded corners 80, 82 of first folding panel 14, along the upper edge 18 thereof, and rounded corners 84, 86, of second folding panel 16, along the edge 32 thereof. For foldable clipboard 110, corners 80 and 82 of first folding panel 14 are rounded along the upper edge 18 thereof, and the third folding panel 54 includes rounded corners 88, 90 along the lower edge 58 of the third folding panel 54.

Referring to FIGS. 1-3, a method of use for foldable clipboard 10 is illustrated. From an expanded position, as illustrated in FIGS. 1, 4, and 5, the first folding panel 14, the second folding panel 16, or both are moved toward the lower surfaces 28, 40 of each other, respectively, as shown in FIG. 2, until the lower surfaces 28, 40 of first and second folding panels 14, 16 overlap each other and are positioned adjacent each other, in a folded position, as illustrated in FIG. 3. To move the first and second folding panels 14, 16, the method is reversed, until each neck 71 of each cylindrical hinge 41a-41d abut one of each stop 50a-50d, and each neck 71 of each cylindrical hinge 46a-46d abuts one or each stope 48a-48d to re-form the expanded position.

Referring to FIGS. 10, 17, and 18, a method of use for foldable clipboard 110 is illustrated. From an expanded position, as illustrated in FIG. 10, the first folding panel 14, the third folding panel 54, or both, are moved toward the lower surface 40 of the second folding panel 16, until the lower surface 66 of the third folding panel 54 overlaps the lower surface 40 of the second folding panel 16, and then the lower surface 28 of the first folding panel 14 overlaps the upper surface 64 of the third folding panel 34, as shown in FIG. 18, although it will be understood that the first folding panel 14 may overlap the second folding panel, while the third folding panel may overlap the first folding panel as well (not shown), in the folded position To move back to the expended position, the method is reversed, until the stops 48a-48d and 50a-50d of each of the first and second plurality of hinge assemblies 42, 43 abut each other to re-form the expanded position. It will be understood that the folding panels of the foldable clipboards 10 and 110 cooperate to form a single flat, planar surface in the expanded position which is rigid and suitable for securing documents (not shown) and/or providing a writing surface to hold writing material (not shown) thereupon. In the folded position, the foldable clipboards 10, 110 may be positioned in a pocket, a purse, a briefcase, a pack, and the like.

While the clip 12 is positioned on an upper surface 18 of the first folding panel 14, it will be understood that the clip 12 is excluded from the consideration of the planar expanded position, and the clip 12 is desirably a low-profile clip as illustrated or could be formed partially or totally within the first folding panel 14 to more closely conform to the planar formation of the foldable clipboards 10, 110 (not shown). Alternatively, the clip 12 could be provided separately and attached to any portion of the foldable clipboards 10, 110 by any means known in the art and commercially available. In yet another alternative, the foldable clipboards 10, 110 may be provided without a clip.

The foldable clipboards 10, 110 may include additional features, including one shown in U.S. non-provisional patent application Ser No. 17/555,472, now U.S. Pat. No. 11,872,835 which illustrates one writing implement holder for a pencil, pen, and the like, connected to an alternative foldable clipboard. However, it will be appreciated that any writing implement holder of any configuration which is known and commercially available may be utilized and connected to or formed with any portion of the foldable clipboards 10, 110, so long as the foldable clipboards 10, 110 operates as shown and described herein.

Although the invention has been shown and described concerning a certain preferred embodiment or embodiments, certain equivalent alterations and modifications will occur to others skilled in the art upon the reading and understanding of this specification and the annexed drawings. In particular regard to the various functions performed by the above- described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed concerning only one of several embodiments, such feature may be combined with one or more features of the other embodiments as may be desired and advantageous for any given or particular application.

What is claimed is:

1. A foldable clipboard, comprising:
at least two folding panels which are configured to form a single planar surface when positioned in an expanded position when one edge of each of the at least two folding panels is positioned next to another edge of each of the at least two folding panels to abut to provide a planar expanded position;
at least one plurality of hinge assemblies, each hinge of the plurality of hinge assemblies positioned in a transverse alignment relative to each other, a portion of the hinges of the at least one plurality of hinge assemblies carried along the one edge of one of the at least two folding panels, and another portion of the hinges of the at least one plurality of hinge assemblies carried along the other edge of the other of the at least two folding panels to pivotally connect together the at least two folding panels,
wherein each hinge of the at least one plurality of hinge assemblies is substantially cylindrical and includes a stop to provide a first plurality of stops, and wherein another stop is formed adjacent each hinge on each edge of the at least first and second folding panels between each hinge of the at least one plurality of hinges to provide a second plurality of stops, such that when the at least first and second folding panels are moved into the expanded position, one stop of the plurality of first stops provided with each hinge abuts one stop of the second plurality of stops formed along each edge, respectively, to form the expanded position, and
wherein when the at least two panels of the foldable clipboard are moved from the expanded position into a folded position, each stop of the first plurality of stops moves away from each stop of the second plurality of stops so that the at least first and second folding panels move into an overlapped relative to each other to provide a folded position.

2. The foldable clipboard of claim 1, wherein the at least one plurality of hinge assemblies comprises at least a first hinge and a second hinge, and each of the at least first hinge and second hinge includes one stop of the first plurality of stops, wherein the at least first hinge of the at least two hinges is carried by the one edge of the at least two folding panels and the at least second hinge is carried by the other edge of the at least two folding panels.

3. The foldable clipboard of claim 2, wherein each hinge of the first plurality of the hinge assemblies includes a substantially cylindrical hinge with an opening formed therethrough formed from a neck which forms a stop.

4. The foldable clipboard of claim 3, further comprising a second plurality of stops, including at least a first stop positioned transversely next to one of the first and second hinges, and a second stop positioned transversely next to the other of the first and second hinges.

5. The foldable clipboard of claim 2, wherein the substantially cylindrical hinge includes at least a portion of a pin positioned through the opening therein.

6. The foldable clipboard of claim 1, wherein the at least first and second folding panels fold transversely relative to an axial alignment of the foldable clipboard when in the expanded position.

7. The foldable clipboard of claim 1, further comprising clip.

8. The foldable clipboard of claim 7, wherein the clip is a spring-loaded clip, and wherein, the clip includes a mounting bracket connected to the foldable clipboard.

9. The foldable clipboard of claim 1, wherein a pair of ends of the first folding panel are each rounded, and wherein a pair of ends of the fourth folding panel are each rounded.

10. The foldable clipboard of claim 1, wherein the at least two panels are constructed from at least one of metal, plastic, and cardboard.

11. The foldable clipboard of claim 1, wherein the foldable clipboard further comprises a third folding panel.

12. The foldable clipboard of claim 11, wherein at least one of the first folding panel and the third folding panel overlaps the second folding panel to form the folded position.

13. The foldable clipboard of claim 11 wherein the plurality of hinge assemblies comprises at least a first plurality of hinge assemblies and a second plurality of hinge assemblies, wherein each of the second plurality of hinge assemblies comprises at least a first hinge and a second hinge, and each of the at least first hinge and second hinge includes one stop of the first plurality of stops, wherein the at least first hinge of the at least two hinges is carried by one edge of the at least second panel and the third folding panel, and wherein the at least second hinge is carried by another edge of the at least second folding panel and the third folding panel.

14. The foldable clipboard of claim 13, wherein each hinge of the second plurality of the hinge assemblies includes a substantially cylindrical hinge with an opening formed therethrough formed from a neck which forms a stop.

15. The foldable clipboard of claim 14, further comprising a second plurality of stops, including at least a first stop positioned transversely next to one of the first and second hinges, and a second stop positioned transversely next to the other of the first and second hinges.

16. The foldable clipboard of claim 15, wherein each hinge assembly of the second plurality of the hinge assemblies includes a substantially cylindrical hinge with an opening therethrough and a stop.

17. The foldable clipboard of claim 16, wherein the substantially cylindrical hinge includes at least a portion of a pin positioned through the opening therein.

18. The foldable clipboard of claim 11, wherein the first folding panel, the second folding panel, and the third folding panel fold transversely to form the folded position relative to an axial alignment of the foldable clipboard when in the expanded position.

19. The foldable clipboard of claim 11, further comprising clip.

20. The foldable clipboard of claim 19, wherein the clip is a spring-loaded clip, and wherein the clip includes a mounting bracket connected to the foldable clipboard.
